(19) United States
(12) Patent Application Publication
(10) Pub. No.: US 2018/0078916 A1
(43) Pub. Date: Mar. 22, 2018

(54) LIGNIN-BASED SURFACTANTS

(71) Applicant: CARNEGIE MELLON UNIVERSITY, PITTSBURGH, PA (US)

(72) Inventors: NEWELL R. WASHBURN, Pittsburgh, PA (US); KEDAR PERKINS, Fuquay Varina, NC (US); CHETALI GUPTA, Pittsburgh, PA (US)

(21) Appl. No.: 15/558,818

(22) PCT Filed: Mar. 18, 2016
(86) PCT No.: PCT/US2016/023189

§ 371 Date: Sep. 15, 2017

Related U.S. Application Data
(60) Provisional application No. 62/177,561, filed on Mar. 18, 2015.
(60) Provisional application No. 62/178,643, filed on Apr. 15, 2015.

(51) Int. Cl. B01F 17/00; C04B 24/32; C04B 24/18; C04B 28/04; A01N 25/30; C08H 7/00

(52) U.S. Cl. CPC B01F 17/0057; B01F 17/0028; C04B 24/32; C04B 2103/40; C04B 28/04; A01N 25/30; C08H 6/00; C04B 24/18

(57) ABSTRACT

A composition includes a polymer-grafted lignin formed by grafting one or more hydrophilic polyalkylene oxide polymers with lignin, wherein the average grafting density of the polymer-grafted lignin is less than 10 per lignin particle and the weight fraction of the one or more hydrophilic polyalkylene oxide polymers in the polymer grafted lignin is less than 40%.

### CROSS-REFERENCE TO RELATED APPLICATIONS

This application claims benefit of U.S. Provisional Patent Application Ser. No. 62/177,561, filed Mar. 18, 2015, and U.S. Provisional Patent Application Ser. No. 62/178,643, filed Apr. 15, 2015, the disclosures of which are incorporated herein by reference.

### GOVERNMENTAL INTEREST

This invention was made with government support under grant no. CBET-1510600 awarded by the National Science Foundation. The government has certain rights in this invention.

### BACKGROUND

The following information is provided to assist the reader in understanding technologies disclosed below and the environment in which such technologies may typically be used. The terms used herein are not intended to be limited to any particular narrow interpretation unless clearly stated otherwise in this document. References set forth herein may facilitate understanding of the technologies or the background thereof. The disclosure of all references cited herein are incorporated by reference.

Lignin is an abundant phenolic polymer found in nature and, therefore, is a potential sustainable building block of industrial materials. Lignin is a complex biopolymer that is a key structural component of woody plants. Purified lignin is generated in large quantities by, for example, the pulp and paper industry but it is not used extensively in modern materials because of its low reactivity and poor processability. Moreover, the incorporation of lignin into a number of materials has resulted in inconsistent material properties. Nonetheless, a goal for the effective handling of lignin waste involves the formation of lignin-based materials. For decades, these materials have been a source of interest because lignin is a natural, renewable source of carbon. Engineering uses for waste materials into high-performance materials would positively affect the environmental cost of producing these materials.

Biobased surfactants include anionic species based on hydrolyzed oils, cationic species based on the amino acid arginine, and nonionic species based on alkyl polyglycosides. These offer high levels of interfacial activity with lower environmental impact and have been studied extensively and used broadly in a range of applications. Biobased surfactants resemble purely synthetic surfactants with polar head groups and non-polar alkyl tails.

Surfactants based on lignin have also been used in a broad range of applications, with lignosulfonates being the most broadly studied and used. Lignosulfonates, prepared through sulfite treatment of lignins, have, for example, been used as stabilizers in oil/water emulsions, surfactants in enhanced oil recovery, and plasticizers in concrete. However, most lignin-based surfactants have provided only modest results. The anionic sulfonate group of lignosulfonates increases the hydrophilicity of lignin much like the phenoxide groups under basic conditions. Although a number of chemical strategies have been used to strengthen the amphiphilic interactions of lignin and lignosulfonate, most such strategies have met with only limited success.

### SUMMARY

In one aspect, a composition includes a polymer-grafted lignin formed by grafting one or more hydrophilic polyalkylene oxide polymers with lignin, wherein the average grafting density of the polymer-grafted lignin is less than 10 per lignin particle. In a number of embodiments, the weight fraction of the one or more hydrophilic polyalkylene oxide polymers in the polymer grafted lignin is less than 40%. In a number of embodiments, the average grafting density of the polymer-grafted lignin is no more than 6 per lignin particle or no more than 3 per lignin particle. In a number of embodiments, the weight fraction of the one or more hydrophilic polyalkylene oxide polymers in the polymer grafted lignin is less than 30% or less than 20%. The one or more hydrophilic polyalkylene oxide polymers may, for example, be polyethylene glycol polymers. In a number of embodiments, the one or more hydrophilic polyalkylene oxide polymers have a degree of polymerization in the range of 5 to 1000, 5 to 500 or 5 to 100.

The lignin may, for example, be selected from the group consisting of a kraft lignin and a lignosulfonate. In a number of embodiments, the lignin is a lignosulfonate.

In a number of embodiments, the one or more hydrophilic polyalkylene oxide polymers to be grafted to the lignin have an average functionality of no more than 1.5 or no more than 1.25.

In another aspect, a composition includes at least one aqueous liquid phase, and a surfactant within the at least one aqueous liquid phase which is suitable to lower the surface tension at a liquid-solid, liquid-liquid or a liquid-gas phase boundary. The surfactant includes a polymer-grafted lignin formed by grafting one or more hydrophilic polyalkylene oxide polymers with lignin, wherein an average grafting density of the polymer-grafted lignin is less than 10 per lignin particle. In a number of embodiments, the weight fraction of the one or more hydrophilic polyalkylene oxide polymers in the polymer grafted lignin is less than 40%. As described above, the average grafting density of the polymer-grafted lignin may be no more than 6 per lignin particle or no more than 3 per lignin particle. In a number of embodiments, the weight fraction of the one or more hydrophilic polyalkylene oxide polymers in the polymer grafted lignin is less than 30% or less than 20%. The one or more hydrophilic polyalkylene oxide polymers may, for example, be polyethylene glycol polymers. In a number of embodiments, the one or more hydrophilic polyalkylene oxide polymers have a degree of polymerization in the range of 5 to 1000, 5 to 500 or 5 to 100.

The lignin may, for example, be selected from the group consisting of a kraft lignin and a lignosulfonate. In a number of embodiments, the lignin is a lignosulfonate.

In a number of embodiments, the one or more hydrophilic polyalkylene oxide polymers to be grafted to the lignin have an average functionality of no more than 1.5 or no more than 1.25.

In another aspect, a composition, includes at least one aqueous liquid phase, a carrier agent including a polymer-grafted lignin formed by grafting one or more hydrophilic polyalkylene oxide polymers with lignin, wherein an average grafting density of the polymer-grafted lignin is less than 10 per lignin particle. In a number of embodiments, the weight fraction of the one or more hydrophilic polyalkylene oxide polymers in the polymer grafted lignin is less than 40%, at least one hydrophobic entity associated with the carrier agent. The polymer-grafted lignin may, for example, be further described as set forth above.

In another aspect, a method of lowering a surface tension at a liquid-solid, liquid-liquid or a liquid-gas phase boundary in a composition including a liquid aqueous phase includes adding a surfactant to the liquid aqueous phase, the surfactant comprising a polymer-grafted lignin formed by grafting one or more hydrophilic polyalkylene oxide polymers with lignin, wherein an average grafting density of the polymer-grafted lignin is less than 10 per lignin particle. In a number of embodiments, the weight fraction of the one or more hydrophilic polyalkylene oxide polymers in the polymer grafted lignin is less than 40%. The polymer-grafted lignin may, for example, be further described as set forth above.

In another aspect, a method of delivering a hydrophobic compound in an aqueous medium includes associating the hydrophobic compound with a carrier agent comprising a polymer-grafted lignin formed by grafting one or more hydrophilic polyalkylene oxide polymers with lignin, wherein an average grafting density of the polymer-grafted lignin is less than 10 per lignin particle. In a number of embodiments, the weight fraction of the one or more hydrophilic polyalkylene oxide polymers in the polymer grafted lignin is less than 40%. The polymer-grafted lignin may, for example, be further described as set forth above.

In another aspect, a method of forming a composition includes grafting one or more hydrophilic polyalkylene oxide polymers with lignin to form a polymer-grafted lignin, wherein and average grafting density of the polymer-grafted lignin is less than 10 per lignin particle. In a number of embodiments, the weight fraction of the one or more hydrophilic polyalkylene oxide polymers in the polymer grafted lignin is less than 40%. The polymer-grafted lignin may, for example, be further described as set forth above.

In another aspect, a composition includes a polymer-grafted lignin formed by grafting one or more hydrophilic polymers formed via a polymerization technique other than controlled radical polymerization, wherein an average grafting density of the polymer-grafted lignin is less than 10 per lignin particle. In a number of embodiments, the weight fraction of the one or more hydrophilic polymers in the polymer grafted lignin is less than 40%. The polymerization technique may, for example, include ionic polymerization, condensation polymerization or ring-opening polymerization. In a number of embodiments, the polymerization technique includes ionic polymerization.

In a number of embodiments, the average grafting density of the polymer-grafted lignin is no more than 6 per lignin particle or no more than 3 per lignin particle. In a number of embodiments, the weight fraction of the one or more hydrophilic polymers in the polymer grafted lignin is less than 30% or less than 20%. The one or more hydrophilic polymers may, for example, be polyethylene glycol polymers, polyamides or polycarbonates. In a number of embodiments, the one or more hydrophilic polymers have a degree of polymerization in the range of 5 to 1000, 5 to 500 or 5 to 100.

The lignin may, for example, be selected from the group consisting of a kraft lignin and a lignosulfonate. In a number of embodiments, the lignin is a lignosulfonate.

In a number of embodiments, the one or more hydrophilic polymers to be grafted to the lignin have an average functionality of no more than 1.5 or no more than 1.25.

In another aspect, a composition includes at least one aqueous liquid phase and a surfactant within the at least one aqueous liquid phase which is suitable to lower the surface tension at a liquid-solid, liquid-liquid or a liquid-gas phase boundary. The surfactant is formed by grafting one or more hydrophilic polymers formed via a polymerization technique other than controlled radical polymerization with lignin, wherein an average grafting density of the polymer-grafted lignin is less than 10 per lignin particle. In a number of embodiments, the weight fraction of the one or more hydrophilic polymers in the polymer grafted lignin is less than 40%. The polymerization technique may, for example, include ionic polymerization, condensation polymerization or ring-opening polymerization. In a number of embodiments, the polymerization technique includes ionic polymerization.

In a number of embodiments, the average grafting density of the polymer-grafted lignin is no more than 6 per lignin particle or no more than 3 per lignin particle. In a number of embodiments, the weight fraction of the one or more hydrophilic polymers in the polymer grafted lignin is less than 30% or less than 20%. The one or more hydrophilic polymers may, for example, be polyethylene glycol polymers, polyamides or polycarbonates. In a number of embodiments, the one or more hydrophilic polymers have a degree of polymerization in the range of 5 to 1000, 5 to 500 or 5 to 100.

The lignin may, for example, be selected from the group consisting of a kraft lignin and a lignosulfonate. In a number of embodiments, the lignin is a lignosulfonate.

In a number of embodiments, the one or more hydrophilic polymers to be grafted to the lignin have an average functionality of no more than 1.5 or no more than 1.25.

In another aspect, a method of lowering a surface tension at a liquid-solid, liquid-liquid or a liquid-gas phase boundary in a composition including a liquid aqueous phase, comprising adding a surfactant to the liquid aqueous phase, the surfactant comprising a polymer-grafted lignin formed by grafting one or more hydrophilic polymers formed via a polymerization other than controlled radical polymerization with lignin, wherein an average grafting density of the polymer-grafted lignin is less than 10 per lignin particle. In a number of embodiments, the weight fraction of the one or more hydrophilic polymers in the polymer grafted lignin is less than 40%. As described above, the polymerization technique may, for example, include ionic polymerization, condensation polymerization or ring-opening polymerization. In a number of embodiments, the polymerization technique includes ionic polymerization.

In a number of embodiments, the average grafting density of the polymer-grafted lignin is no more than 6 per lignin particle or no more than 3 per lignin particle. In a number of embodiments, the weight fraction of the one or more hydrophilic polymers in the polymer grafted lignin is less than 30% or less than 20%. The one or more hydrophilic polymers may, for example, be polyethylene glycol polymers, polyamides or polycarbonates. In a number of embodiments, the one or more hydrophilic polymers have a degree of polymerization in the range of 5 to 1000, 5 to 500 or 5 to 100.

The lignin may, for example, be selected from the group consisting of a kraft lignin and a lignosulfonate. In a number of embodiments, the lignin is a lignosulfonate.

In a number of embodiments, the one or more hydrophilic polymers to be grafted to the lignin have an average functionality of no more than 1.5 or no more than 1.25.

A method of forming a composition comprising grafting one or more hydrophilic polymers formed a polymerization technique other that controlled radical polymerization as described above with a lignin to form a polymer-grafted lignin, wherein an average grafting density of the polymer-grafted lignin is less than 10 per lignin particle. In a number of embodiments, the weight fraction of the one or more hydrophilic polyalkylene oxide polymers in the polymer grafted lignin is less than 40%.

A composition, comprising: at least one aqueous liquid phase, a carrier agent comprising a polymer-grafted lignin formed by grafting one or more hydrophilic polymers formed via a polymerization technique other than controlled radical polymerization as described above with lignin, wherein an average grafting density of the polymer-grafted lignin is less than 10 per lignin particle. In a number of embodiments, the weight fraction of the one or more hydrophilic polymers in the polymer grafted lignin is less than 40%, at least one hydrophobic entity associated with the carrier agent.

A method of delivering a hydrophobic compound in an aqueous medium, comprising: associating the hydrophobic compound with a carrier agent comprising a polymer-grafted lignin formed by grafting one or more hydrophilic polymers formed via a polymerization technique other than controlled radical polymerization as described above with lignin, wherein an average grafting density of the polymer-grafted lignin is less than 10 per lignin particle. In a number of embodiments, the weight fraction of the one or more hydrophilic polymers in the polymer grafted lignin is less than 40%.

In another aspect, a composition includes a polymer-grafted lignosulfonate formed by grafting one or more hydrophilic polymers with a lignosulfonate to form a polymer-grafted lignin. In a number of embodiments, an average grafting density of the polymer-grafted lignin is less than 10 per lignosulfonate particle. In a number of embodiments, the weight fraction of the one or more hydrophilic polymers in the polymer grafted lignin is less than 40%. The hydrophilic polymers may, for example, be formed via a polymerization technique other than controlled radical polymerization. The hydrophilic polymers may, for example, be formed via ionic polymerization, condensation polymerization or ring-opening polymerization. In a number of embodiments, the polymerization technique includes ionic polymerization.

In a number of embodiments, the average grafting density of the polymer-grafted lignin is no more than 6 per lignin particle or no more than 3 per lignin particle. In a number of embodiments, the weight fraction of the one or more hydrophilic polymers in the polymer grafted lignin is less than 30% or less than 20%. The one or more hydrophilic polymers may, for example, be polyethylene glycol polymers, polyamides or polycarbonates. In a number of embodiments, the one or more hydrophilic polymers have a degree of polymerization in the range of 5 to 1000, 5 to 500 or 5 to 100. In a number of embodiments, the one or more hydrophilic polymers to be grafted to the lignin have an average functionality of no more than 1.5 or no more than 1.25.

In another aspect, a composition includes at least one aqueous liquid phase and a surfactant within the at least one aqueous liquid phase which is suitable to lower the surface tension at a liquid-solid, liquid-liquid or a liquid-gas phase boundary, the surfactant comprising a polymer-grafted lignin formed by grafting one or more hydrophilic polymers with a lignosulfonate. In a number of embodiments, an average grafting density of the polymer-grafted lignin is less than 10 per lignosulfonate particle. In a number of embodiments, the weight fraction of the one or more hydrophilic polymers in the polymer grafted lignin is less than 40%. In a number of embodiments, the weight fraction of the one or more hydrophilic polymers in the polymer grafted lignin is less than 40%. The hydrophilic polymers may, for example, be formed via a polymerization technique other than controlled radical polymerization. The hydrophilic polymers may, for example, be formed via ionic polymerization, condensation polymerization or ring-opening polymerization. In a number of embodiments, the polymerization technique includes ionic polymerization.

In a number of embodiments, the average grafting density of the polymer-grafted lignin is no more than 6 per lignin particle or no more than 3 per lignin particle. In a number of embodiments, the weight fraction of the one or more hydrophilic polymers in the polymer grafted lignin is less than 30% or less than 20%. The one or more hydrophilic polymers may, for example, be polyethylene glycol polymers, polyamides or polycarbonates. In a number of embodiments, the one or more hydrophilic polymers have a degree of polymerization in the range of 5 to 1000, 5 to 500 or 5 to 100. In a number of embodiments, the one or more hydrophilic polymers to be grafted to the lignin have an average functionality of no more than 1.5 or no more than 1.25.

In another aspect, method of lowering a surface tension at a liquid-solid, liquid-liquid or a liquid-gas phase boundary in a composition including a liquid aqueous phase, comprising adding a surfactant to the liquid aqueous phase, the surfactant comprising a polymer-grafted lignin formed by grafting one or more hydrophilic polymers with lignosulfonate as described above.

In another aspect, a method of forming a composition comprising grafting one or more hydrophilic polymers with a lignosulfonate to form a polymer-grafted lignin as described above.

In a further aspect, a method of plasticizing cement includes including a kraft lignin in a mixture of cement, a polycarboxylate ether-based superplasticizer, and water.

In still a further aspect, a cementitious composition includes a kraft lignin, cement, a polycarboxylate ether-based superplasticizer, and water.

The present methods and compositions, along with the attributes and attendant advantages thereof, will best be appreciated and understood in view of the following detailed description taken in conjunction with the accompanying drawings.

### BRIEF DESCRIPTION OF THE DRAWINGS

FIG. 1A illustrates a schematic representation of a polymer-grafted lignin particle hereof.

FIG. 1B illustrates an embodiment of a representative synthetic scheme for synthesis of polyethylene-glycol-grafted or PEG-grafted lignin, wherein monomethoxy PEG is grafted onto lignosulfonate.

FIG. 1C illustrates another embodiment of a synthetic scheme for synthesis of polyethylene-glycol-grafted or PEG-grafted lignin.

FIG. 2A illustrates a representation of the molecular structure of a lignosulfonate in the form of sodium lignosulfonate.

FIG. 2B illustrates a representation of the molecular structure of a kraft lignin.

FIG. 2C illustrates a representation of the molecular structure of a polycarboxylate ether (PCE).

FIG. 3 illustrates the results of zeta potential measurements of PCE, kraft lignin, and lignosulfonate.

FIG. 4 illustrates slump spread values of Portland cement mixed with water at a water:cement ratio of 0.42 as a neat mixture and mixed with lignosulfonate (LS), kraft lignin (KL), PCE, and 50/50 mixtures of LS and KL with PCE, wherein the total concentration of admixture in each formulation was 0.25 wt % of the total cement weight.

FIG. 5 illustrates viscosity as a function of steady-shear rate for Portland cement mixed with water at a water:cement ratio of 0.42 as a neat mixture and mixed with lignosulfonate (LS), kraft lignin (KL), PCE, and 50/50 mixtures of LS and KL with PCE, wherein the total concentration of admixture in each formulation was 0.25 wt % of the total cement weight.

FIG. 6 illustrates the slump spread values of Portland cement mixed with water at a water:cement ratio of 0.42 as a neat mixture and mixed with PEGylated or PEG-grafted lignosulfonate (LSPEG), kraft lignin (KLPEG), PCE, and 50/50 mixtures of LS and KL with PCE, wherein the total concentration of admixture in each formulation was 0.25 wt % of the total cement weight.

FIG. 7 illustrates viscosity as a function of steady-shear rate for Portland cement mixed with water at a water: cement ratio of 0.42 as a neat mixture and mixed with PEGylated or PEG-grafted lignosulfonate (LSPEG), kraft lignin (KLPEG), PCE, and 50/50 mixtures of LS and KL with PCE, wherein the total concentration of admixture in each formulation was 0.25 wt % of the total cement weight.

FIG. 8 illustrates yield stress testing data of Portland cement containing different lignosulfonate or kraft lignin admixtures from mini-slump tests.

FIG. 9A illustrates a dynamic surface tension study of KLPEG with a PEG graft molecular weight of 900 g/mol.

FIG. 9B illustrates a dynamic surface tension study of KLPEG with a PEG graft molecular weight of 5000 g/mol.

FIG. 9C illustrates a dynamic surface tension study of LSPEG with a PEG graft molecular weight of 900 g/mol.

FIG. 9D illustrates a study of aqueous surface tension measurements of solutions containing LS and LSPEG with PEG graft molecular weights of 900 g/mol, 2000 g/mol, and 5000 g/mol.

FIG. 9E illustrates another study of aqueous surface tension measurements of solutions containing LSPEG with PEG graft molecular weights of 900 g/mol, 2000 g/mol, and 5000 g/mol.

FIG. 9F illustrates a study of aqueous surface tension measurements of solutions containing KLPEG with PEG graft molecular weights of 900 g/mol, 2000 g/mol, and 5000 g/mol.

FIG. 9G illustrates a photograph of 10 mL of lignin grafted PEG (10 mg/mL) was ultrasonicated with 10 mL of cyclohexane after two weeks for KLPEG 900, 2000 and 5000 (left to right).

FIG. 9H illustrates a study of emulsion height for LSPEG and KLPEG with PEG graft molecular weights of 900 g/mol, 2000 g/mol, and 5000 g/mol in cyclohexane at a concentration of 1 mg/mL of LSPEG and KLPEG.

FIG. 9I illustrates a study of emulsion height for LSPEG and KLPEG with PEG graft molecular weights of 900 g/mol, 2000 g/mol, and 5000 g/mol in cyclohexane at a concentration of 10 mg/mL of LSPEG and KLPEG.

FIG. 10 illustrates solutions of the water-insoluble herbicide rotenone: (a) neat, (b) 0.05% KLPEG900 (PEG graft molecular weight of 900 g/mol), (c) 0.1% KLPEG900.

FIG. 11 illustrates images of clethodim application to corn seedlings, wherein adjuvants hereof are compared to commercial adjuvant formulations PRIME OIL® and SUPBERB® HC.

FIG. 12 illustrated a graph wherein percent inhibition is plotted for the different formulations 7 days following treatment.

### DETAILED DESCRIPTION

It will be readily understood that the components of the embodiments, as generally described and illustrated in the figures herein, may be arranged and designed in a wide variety of different configurations in addition to the described representative embodiments. Thus, the following more detailed description of the representative embodiments, as illustrated in the figures, is not intended to limit the scope of the embodiments, as claimed, but is merely illustrative of representative embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

As used herein and in the appended claims, the singular forms “a,” “an”, and “the” include plural references unless the context clearly dictates otherwise. Thus, for example, reference to “a polymer” includes a plurality of such polymers and equivalents thereof known to those skilled in the art, and so forth, and reference to “the polymer” is a reference to one or more such polymers and equivalents thereof known to those skilled in the art, and so forth. Recitation of ranges of values herein are merely intended to serve as a shorthand method of referring individually to each separate value falling within the range. Unless otherwise indicated herein, and each separate value, as well as intermediate ranges, are incorporated into the specification as if individually recited herein. All methods described herein can be performed in any suitable order unless otherwise indicated herein or otherwise clearly contraindicated by the text.

As used herein, the term “polymer” refers to a chemical compound that is made of a plurality of small molecules or monomers that are arranged in a repeating structure to form a larger molecule. Polymers may occur naturally or be formed synthetically. The use of the term “polymer” encompasses homopolymers as well as copolymers. The term “copolymer” is used herein to include any polymer having two or more different monomers. Copolymers may, for example, include alternating copolymers, periodic copolymers, statistical copolymers, random copolymers, block copolymers, graft copolymers etc. Examples of polymers include, for example, polyalkylene oxides.

As described above, lignin is a complex, cross-linked racemic macromolecule or biopolymer that is a key structural component of woody plants. Three monolignol monomers of lignin (which are methoxylated to various degrees), p-coumaryl alcohol, coniferyl alcohol, and sinapyl alcohol, are incorporated into lignin in the form of the phenylpropanoids p-hydroxyphenyl (H), guaiacyl (G), and syringyl (S), respectively. Different types of lignin are described depending on the means of isolation. The size and chemistry of the lignin depends on the source and how the lignin was processed, but the native functional groups in lignin are aromatic, ether, and hydroxyl, which is present in primary, secondary, and phenolic forms. In neutral form, most types of lignin are soluble in dimethyl formamide and pyridine, and the solubility parameter is estimated to be 20-24 MPa^{1/2}. However, the phenolic groups are readily deprotonated, and lignins are soluble in basic aqueous solutions. Lignin may, for example, be obtained from kraft pulping, sulfite pulping, soda process, organic solvent processes, steam explosion processes, and dilute acid (for example, sulfuric acid) processes. In general, any type of lignin can be used in the compositions hereof, including, for example, kraft lignin, solvolysis lignin, organosols lignin, steam exploded lignin, wood waste, natural wood, corn stalk, biopitch, molasses, wood meal and coffee grounds.

In a number of representative examples of a grafting to approach hereof, hydrophilic polymers were grafted to kraft lignin or to lignosulfonate to form surfactants. Lignosulfonates are an anionic derivative of lignin. As used herein, the term “surfactant” is used to refer to a composition including a lignin core and one or more polymer segments grafted thereon, which lower surface tension or interfacial tension in a liquid (for example, between two liquids, between a liquid and a gas or between a liquid and a solid). Surfactants may, for example, act as detergents, wetting agents, emulsifiers, dispersants or foaming agents. An emulsifier is a surfactant which stabilized an emulsion, which is a mixture of two or more liquid that are normally immiscible. A foaming agent facilitates the formation of a foam. A dispersant (including plasticizers and superplasticizers) is added to a suspension to improve separation of particles and prevent settling or climbing.

In a number of embodiments hereof, lignin is grafted with one or more hydrophilic polymers formed via a polymerization process other than a controlled radical polymerization. For example, the hydrophilic polymers may be formed via ionic (anionic or cationic) polymerization. The hydrophilic polymers may also, for example, be produced via condensation polymerization or ring-opening polymerization. Examples of hydrophilic polymers suitable for use herein include polyalkylene oxides, polyamides and polycarbonates.

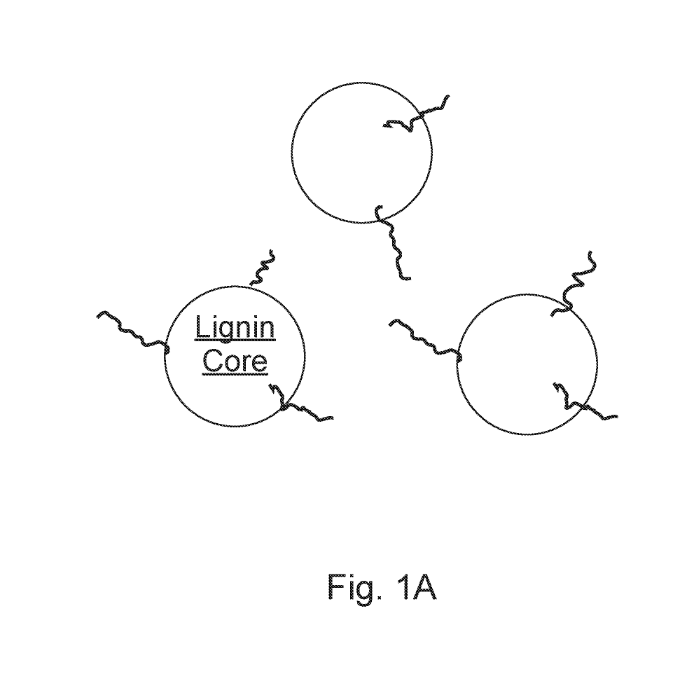

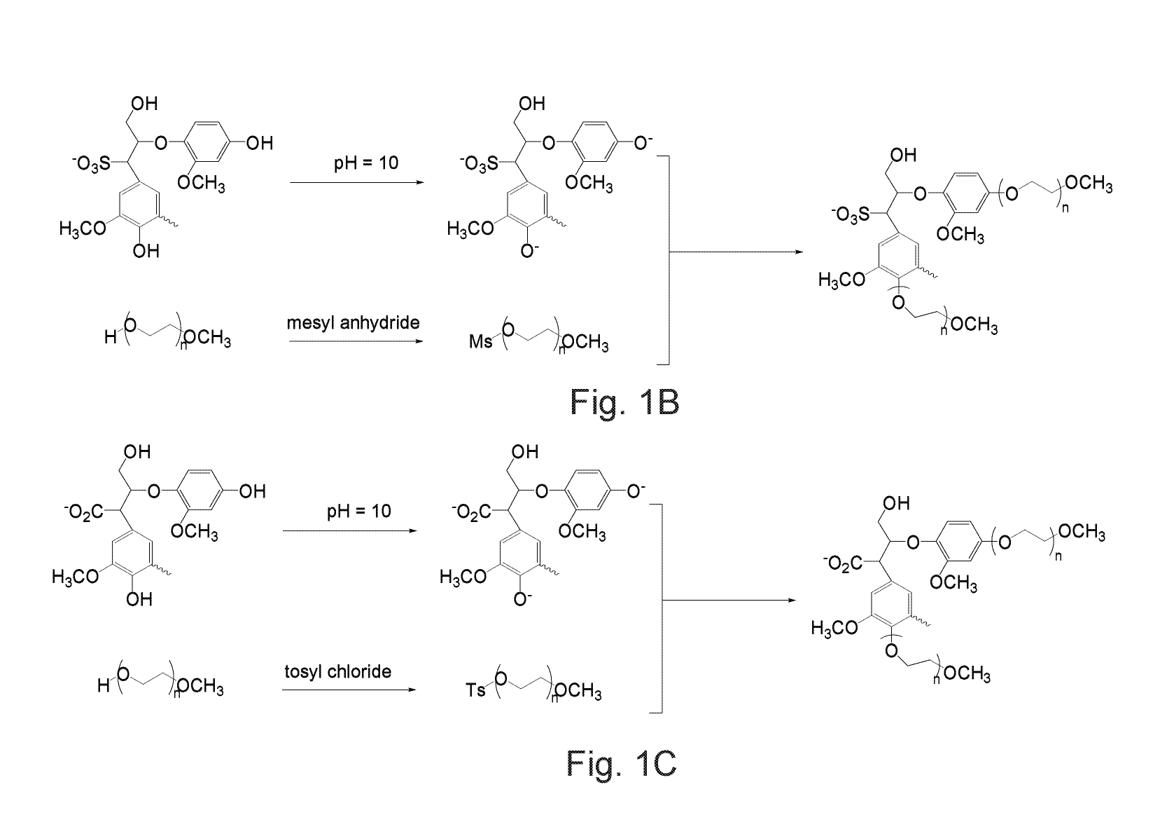

FIG. 1A illustrates an idealized, schematic illustration of a polymer-grafted lignin hereof. As described above, linins may, for example, be grafted with one or more polyalkylene oxide polymers as, for example, illustrated in FIGS. 1B and 1C, which set forth representative examples of synthetic routes to forming lignin grafted with hydrophilic polymers. FIG. 1B illustrates an embodiment of a representative synthetic scheme for synthesis of polyethylene-glycol- or PEG-grafted lignin wherein monomethoxy PEG is grafted onto lignosulfonate. FIG. 1C illustrates another representative example of a reaction scheme of a coupling process for grafting monomethoxy PEG onto kraft lignin. Aromatic hydroxyl groups of lignin may, for example, be deprotonated at pH 10, making them more reactive. The hydroxyl terminus of the PEG may, for example, be made more reactive through modification with tosyl chloride (TsCl) as illustrated in FIG. 1B or with mesyl anhydride as illustrated in FIG. 1C. The representative synthetic schemes of FIGS. 1B and 1C utilize chemistry demonstrated in the functionalization of organosols lignin, but the referenced lignin can lack the strong anionic character commonly associated with lignosulfonates or kraft lignin. The compositions hereof differ significantly from the materials produced following the reaction of lignin such as kraft lignin with PEG having two terminal hydroxyl groups, which result in a crosslinked product. Such crosslinked materials exhibit significantly lower interfacial effects than the compositions hereof.

It is thus desirable in the formation of the polymer-grafted lignins hereof to limit or prevent crosslinking reactions between the hydrophilic polymers which are reacted with the lignin to create polymer-grafted lignin. In a number of embodiments, the reaction conditions under which the grafting of the hydrophilic polymers occurs are controlled to limit or prevent such crosslinking reactions. In that regard, the hydrophilic polymers are functionalized with reactive functional groups to react with functional groups on lignin. In a number of embodiments, the hydrophilic polymers are monofunctionalized (that is, the hydrophilic polymer include only one functional groups). Not all of the hydrophilic polymer need be monofunctionalized, however. In general, crosslinking can be limited or prevented in the case that the average functionality of the polymer reacted with the lignin is less than 2. In a number of embodiments, the average functionality of no more than 1.5, no more than 1.25 or no more than 1.1. The term “average” reflects the fact that the hydrophilic polymers reacted with the lignin can include multiple polymers having different chemical compositions and different functionalities. In that regard, functionality (and other characteristics) can be determined on the basis of molar averages.

Ionic polymerization, for example, provides a facile methodology for synthesis of monoreactive or monofunctional polymers. Alkylene oxide polymers are, for example, readily formed via anionic polymerization to be monofunctional. In a number of embodiments hereof, alkylene oxide polymers are functionalized at one end thereof with a functional group to react with a functional group of lignin and are capped at the other end thereof with a group that is substantially inactive or inactive with lignin and with other alkylene oxide polymers. For example, the alkylene oxide polymers hereof may be capped with an alkyl group (for example, a C₁-C₅ alkyl group). The hydrophilic polymers grafted to lignin (for example, alkylene oxide polymers) are not amphiphilic.

The (average) grafting density of the polymer-grafted lignins hereof is less than 10 polymer chains per lignin particle, no more than 6 polymer chains per lignin particle or no more than 3 polymer chains per lignin particle. In a number of embodiments, the hydrophilic polymer are polyalkylene oxide polymers such polyethylene glycol polymers. The hydrophilic polymers (for example, polyalkylene oxide polymers) may, for example, have a degree of polymerization in the range of, for example, 5 to 1000, 5 to 500 or 5 to 100. The weight fraction of the hydrophilic polymers in the polymer-grafted lignin may, for example, be less 50%, less than 40%, less than 30% or less than 20%. In a number of embodiments, the weight fraction of the hydrophilic polymers in the polymer-grafted lignin is between 5 and 40%, between 5 and 30 or between 5 and 20%.

As used herein, the term “lignin particle” is defined as one or more discrete lignin molecules that are tightly bound as a single species. Lignin particle diameters can, for example, range from 0.5 nm to 200 nm depending on the lignin source, processing methods and solvent conditions. This large size range creates a large range of accessible grafting densities (per unit surface area of the lignin particle), which can, for example, be in the range of approximately 0.00016 to 1.61 grafts per nm², in the range of approximately 0.00016 to 0.16 grafts per nm², in the range of approximately 0.00016 to 0.08 grafts per nm², in the range of approximately 0.00016 to 0.04 grafts per nm², or in the range of approximately 0.00016 to 0.008 grafts per nm². In a number of other embodiments, the average graft density per unit surface area is in the range of approximately 0.0008 to 0.008 grafts per nm² or in the range of approximately 0.0016 to 0.0056 grafts per nm².

The present inventors have discovered that relatively low amounts of the grafted polymers hereof result in significant enhancement of the surface or interfacial activity of the lignin particle. Moreover, the polymer-grafted lignins hereof are effective at relatively low concentrations. The polymers are readily synthesized using, for example, ionic polymerization techniques and grafted to lignin. The polymer-grafted lignin hereof provide an economical manner of modifying readily available lignin to significantly improve the interfacial or surface activity thereof.

In a number of embodiments, the polymer-grafted lignin may, for example, be a kraft lignin and a lignosulfonate. In a number of embodiments, the lignin is a lignosulfonate. Lignosulfonates are inherently hydrophilic in nature. Nonetheless, it was discovered that grafting hydrophilic polymers to hydrophilic lignosulfonates significantly alters the interfacial activity of the polymer-grafted lignin as compared to ungrafted lignins. Hydrophilic polymers such as PEG impart steric/interfacial interactions to lignins that that are not predicted by hydrophile/lipophile balance considerations. The interfacial or surface activity of hydrophilic polymer-grafted lignins is demonstrated with representative studies of the use of such materials as surfactants in cementitious material studies, in surface tension/emulsion studies and in agricultural material studies.

### Cementitious Material Studies

Surfactants or dispersants are, for example, added to cement paste and related products, such as concrete and mortar, to improve the workability of such materials, including, to plasticize the resultant material. Examples include polycarboxylate ethers (PCE) and numerous anionic lignin derivatives, such as kraft lignins and lignosulfonates. PCE is known to provide significant reductions in the yield stress and viscosity of cement paste at given water content, while lignin derivatives, most commonly lignosulfonates, tend to have lower performance. In a number of embodiments hereof, mixtures of PCE and anionic lignins are used in cementitious materials to provide synergistic plasticization of such cementitious materials. In particular, PCE and kraft lignins, which contain anionic carboxylate groups, are shown to offer even greater reduction in yield stress and viscosity than either admixture component alone. Moreover, grafting hydrophilic polymers to lignin and/or lignin oxidation may further enhance performance in these formulations.

In general, a cement is a binder or a substance that sets and hardens. Cements, can for example, bind other materials together. Cement is generally a powdery substance made with calcined lime and clay. Cement may, for example, be mixed with water and aggregate, such as sand, to form mortar or mixed with sand, gravel, other aggregate components, and water to make concrete. Cement includes a variety of natural minerals that react with water to form high-strength solids. Mineral phases of cement are often based on calcium, silicon, and aluminum oxides and hydroxides, that often react with water (hydraulic cement) or carbon dioxide (non-hydraulic cement) to form solids. A number of cements may, for example, be prepared by calcining mineral precursors (for example, lime/limestone and clay) or from natural (pozzolan) sources, such as volcano ash. Some natural sources are referred to as geopolymers, which may, for example, be used directly or with thermal treatment. A number of cements are mixtures of common synthetic cement, such as Portland cement, mixed with other minerals, such as fly ash, silica, zeolites, clays, and limestone (often referred to as Supplementary Cementitious Materials or Alternative Supplementary Cementitious Materials). Non-hydraulic cement will not typically set in wet conditions or underwater. Non-hydraulic cement sets as it dries and reacts with carbon dioxide in the air. Hydraulic cement may, for example, be produced by replacing some of the cement in a mixture with, for example, activated aluminum silicates, pozzolanas, such as fly ash, etc. The chemical reaction results in hydrates that have limited water-solubility. Such hydrates that are durable in water and exhibit improved resistance to chemical attack. Hydraulic cement (for example, Portland cement) may also set in wet condition or underwater. Hydraulic cements can include aggregate, such as sand, gravel, or other solids, resulting in mortar or concrete.

As described above, minerals in, for example, hydraulic cement undergo partial dissolution and remineralization, forming an intermediate phase often referred to as a microgel. This microgel is commonly referred to as cement paste. During this hydration process the mineral particles continue to react with other mineral particles and with water. The hydration chemistry is quite complex and the extent of hydration of the mineral particles is reflected in the observed properties. To promote complete and uniform hydration of this gel phase and to improve workability of the paste, as characterized by the yield stress and viscosity, polymer additives known as plasticizers and superplasticizers may be added. Water-soluble plasticizers and superplasticizers differ from traditional dispersants, which commonly are used to disperse solid particles in a liquid medium, in that effective plasticizers and superplasticizers are involved in the hydration chemistries occurring at the interface between the cementitious particles and the aqueous medium.

Superplasticizers are a class of anionic polymer dispersants used to inhibit aggregation in hydraulic cement, lowering the yield stress of cement pastes to improve workability and reduce water requirements. As described above, lignosulfonates and other forms of lignin have been used as low-cost cement plasticizers, although their performance, as assessed in measurements of reductions of water added to cement powder while still retaining the same workability, is modest. Numerous attempts have been made to improve the performance of lignins in plasticizing cement, but few such modifications have significantly improved the plasticization of hydraulic cement. Recently lignins grafted with polymer formed via controlled radical polymerization have been shown to provide promising results as superplasticizers. See PCT International Patent Application Publication No. 2015/117106, the disclosure of which is incorporated herein by reference. Ionic polymerization techniques to synthesize polymers such as anionic polymerization of hydrophilic but uncharged alkylene oxide polymers may, for example, provide alternatives in syntheses as compared to controlled radical polymerization as well as cost savings. Moreover, the synthetic routes to hydrophilic polymer-grafted lignins hereof are easily scaled for manufacture due to the relative ease with which monoreactive polymers may be produced.

Materials based on lignin and hydrophilic polymers such as poly(ethylene glycol) or PEG exhibit improved properties that are well suited for surfactant applications. As described above, preparation of such polymers may be based on a PEG having, for example, a single reactive end group. Further results show that this PEGylated lignin (for example, kraft lignin or KLPEG) or lignosulfonate (LSPEG) is surface active and, for example, reduces the yield stress of hydraulic cement. The compositions hereof thus provide new type of superplasticizer suitable to reduce viscosity in aqueous cementitious suspensions, but which can be produced with simplified implementation which will increase commercial utility as compared to lignin modified with polymer formed via controlled radical polymerization.

As described above, composition hereof may be used in admixtures for improving the workability of cement, concrete, mortar, and related cementitious materials. In a number of embodiments, such formulations are based on combinations of plasticizing agents that display synergistic effects on workability when added together. Workability of cementitious materials is often assessed using slump tests, which primarily measure yield stress, but also through rheological experiments, which can provide information on viscosity of a material before it sets. Slump tests are the most common measure of hydraulic cement rheology, and are an established first method of characterizing superplasticizers. In the slump tests, cement paste is prepared using standardized mixing conditions and loaded into a metal cone or cylinder, which is raised to allow the cement to flow until the yield stress exceeds the shear stress. The experimental parameters recorded are the change in height and diameter from the original shape. While the complex phenomenon of cement flow is captured in only two geometric parameters, slump tests have the advantage of high levels of reproducibility when conditions are carefully controlled. Slump tests are, for example, further discussed in PCT International Patent Application Publication No. 2015/117106.

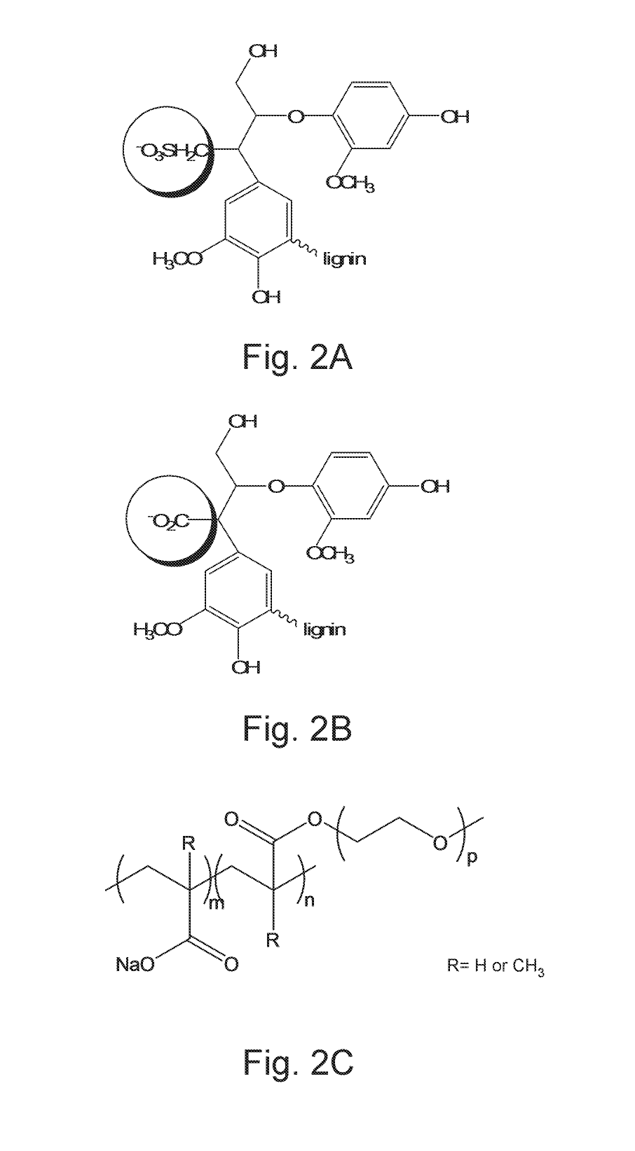

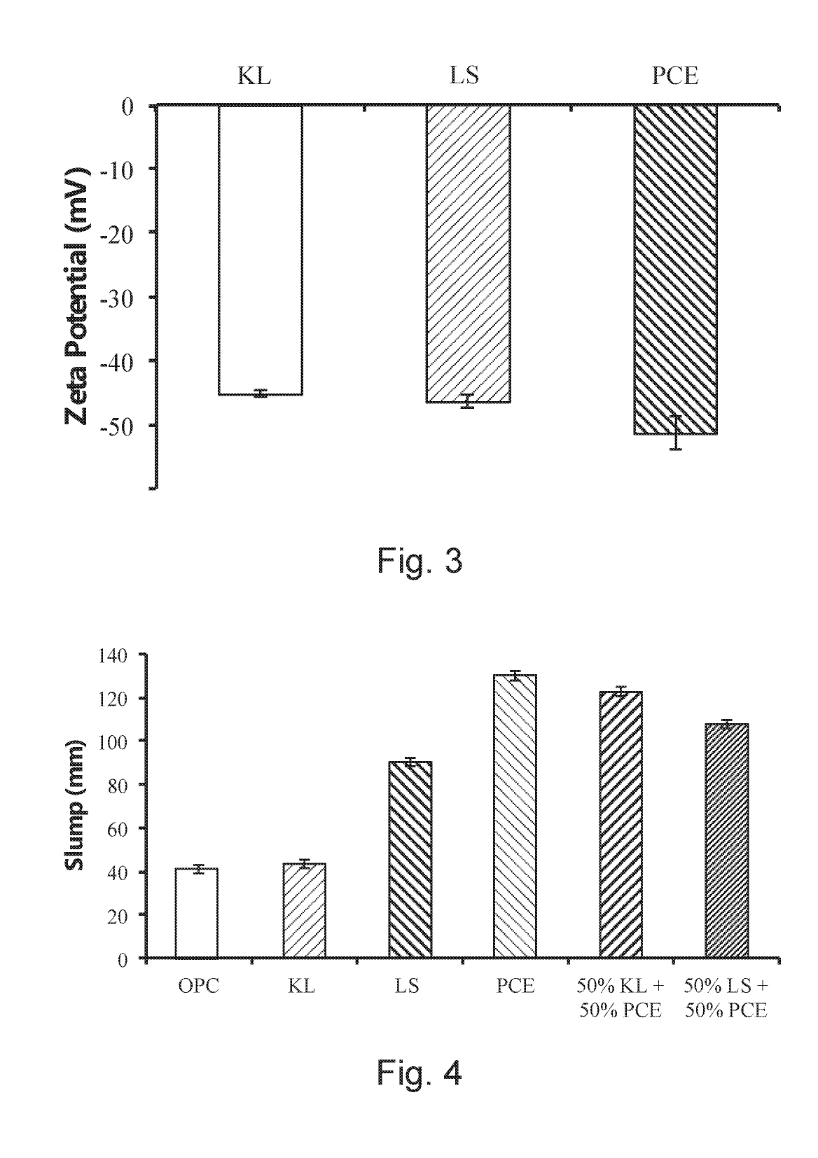

In a number of embodiments of cementitious formulations hereof, polycarboxylate ether (PCE) and kraft lignins and/or polymer-grafted lignins are provided that reduce yield stress and viscosity of cement paste and other cementitious materials. Chemical structures of lignosulfonate (LS), kraft lignin (KL), and PCE are illustrated in FIGS. 2A, 2B and 2C, respectively. The charge of LS, KL and PCE was gauged using zeta potential measurements, and the results are shown in FIG. 3. Each of LS, KL and PCE demonstrates a strongly negative potential consistent with net anionic character.

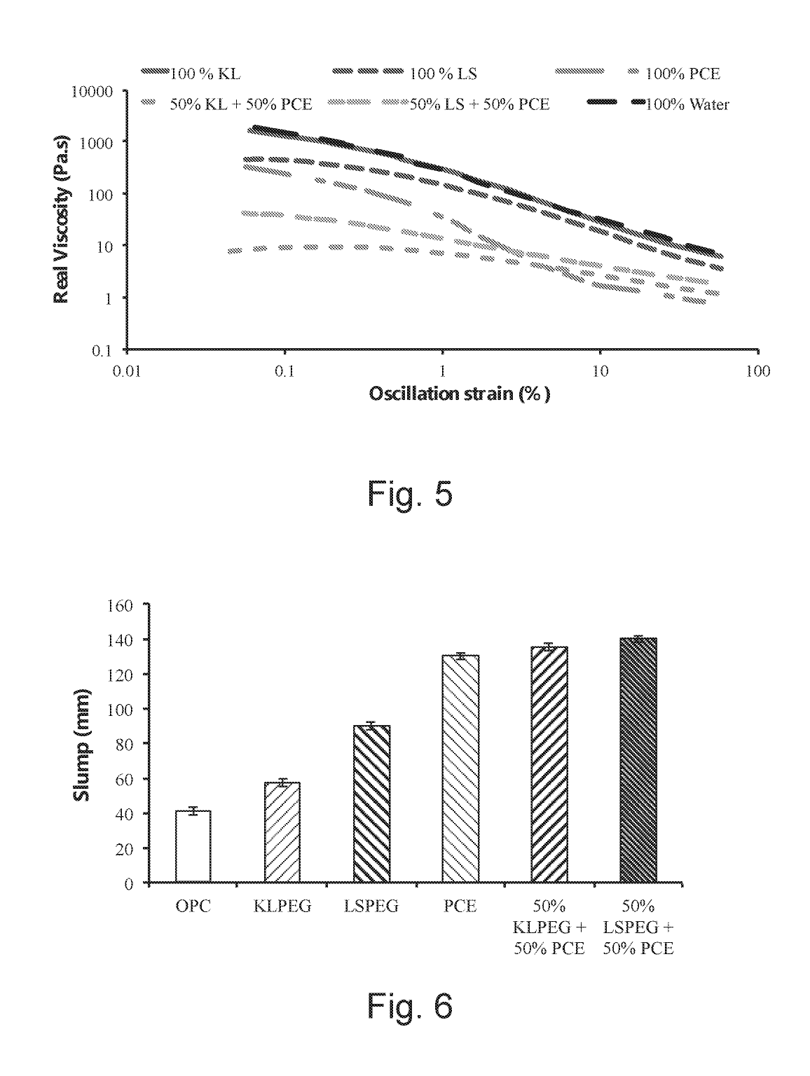

In one study, PCE was blended with LS or KL using equal masses of the PCE and lignin. Changes in yield stress were assessed using slump tests, and the data are presented in FIG. 4. Increases in slump spread are associated with decreases in yield stress, which is an important aspect of cement workability. In cement pastes plasticized with a single admixture component, PCE resulted in the largest increase in slump spread, and LS had the second largest, both of which are well established in the cement literature. In contrast, the change in slump spread with KL was minimal. However, when PCE was blended with KL, the slump spread was nearly unchanged from that of PCE, indicating a synergistic effect. A similar effect was observed in mixtures of PCE and LS, which has been previously reported. However, the effects with KL are unexpected. In that regard, as a single admixture, KL does not lead to improvements in slump spread. Similar trends were observed in measurements of cement-paste viscosity using a stress-controlled rheometer with a vane fixture, as shown in FIG. 5, further indicating a significant synergistic enhancement in cement workability.

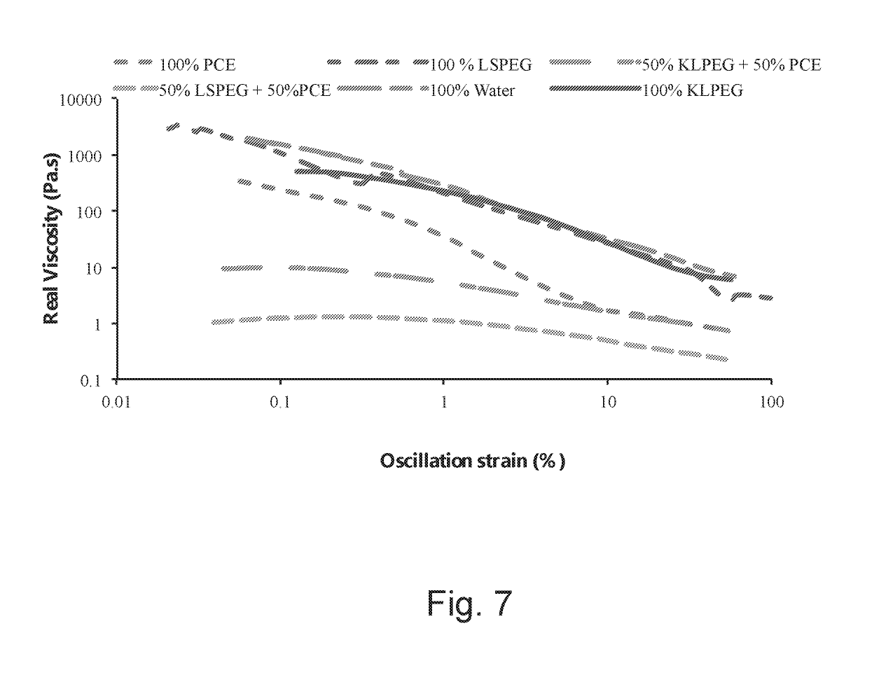

Grafting hydrophilic synthetic polymers onto lignin enhances the effectiveness in plasticization of cement. FIG. 6 illustrates slump data analogous to that described above for LS and KL grafted with poly(ethylene glycol) (PEG). FIG. 7 illustrates analogous viscosity data. Combinations of PCE and LSPEG or KLPEG generally result in greater slump spread and lower viscosity than any single admixture, suggesting synergistic effects in improving the workability of cement paste.

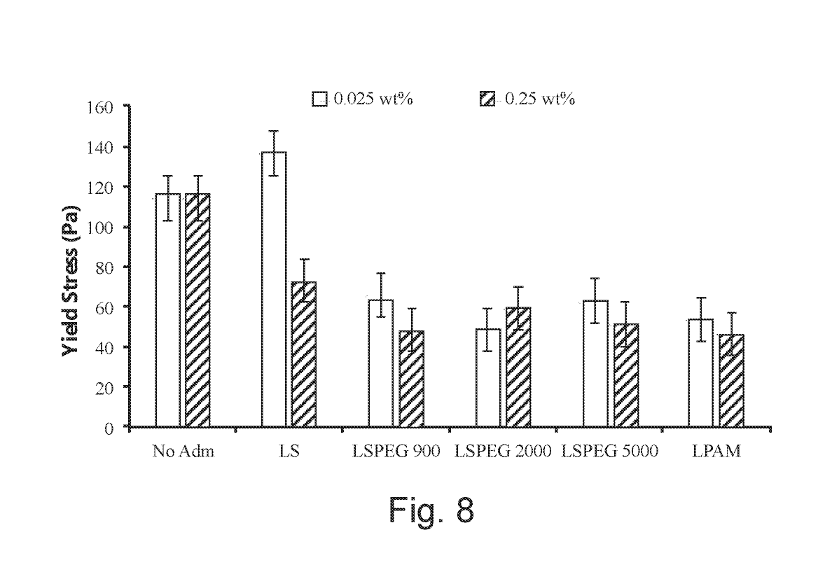

Results for yield stress as calculated from slump spread at concentrations of 0.025 wt % and 0.25 wt % LSPEG in ordinary Portland cement at a water:cement ratio of 0.42 are shown in FIG. 8. The results are compared to non-grafted lignosulfonate and polyacrylamide-grafted kraft lignin (LPAM) at the same concentrations. PEG grafting is demonstrated to reduce the yield stress of cement pastes significantly.

### Surface Tension/Emulsion Studies

Further results of studies of LSPEG demonstrated that the materials exhibited statistically significant reductions in surface tension in, for example, aqueous media. PEGylated lignosulfonate of LSPEG is surface active and reduces the yield stress of hydraulic cement as described above.

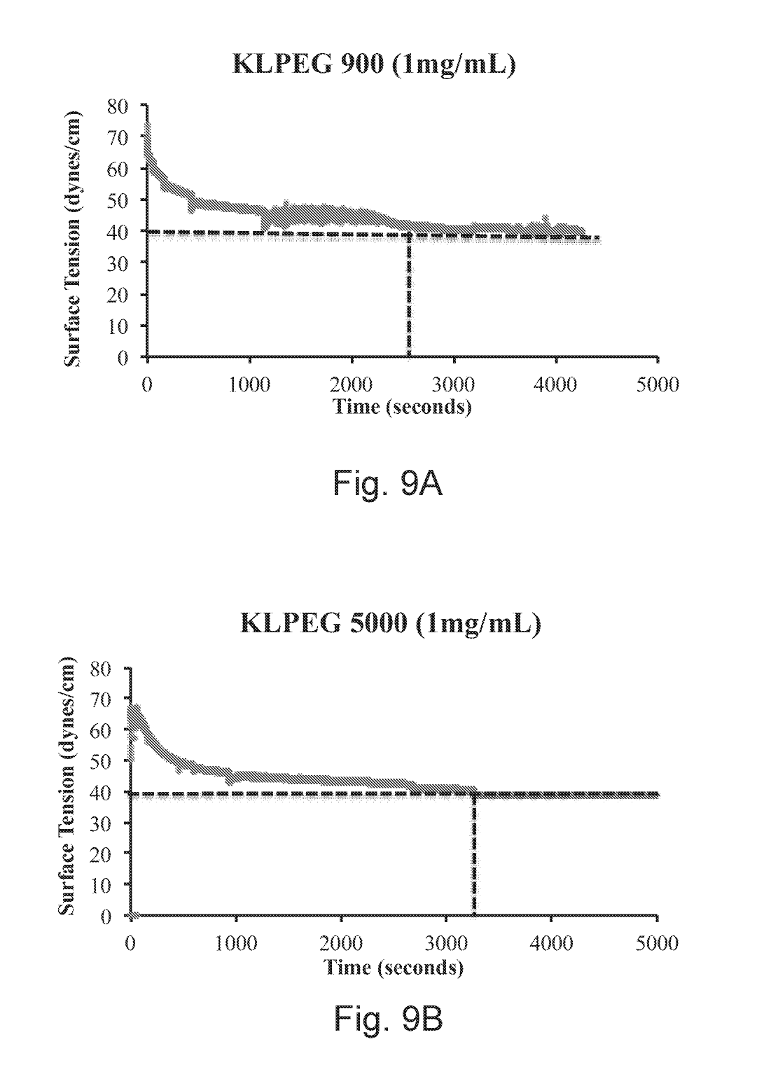

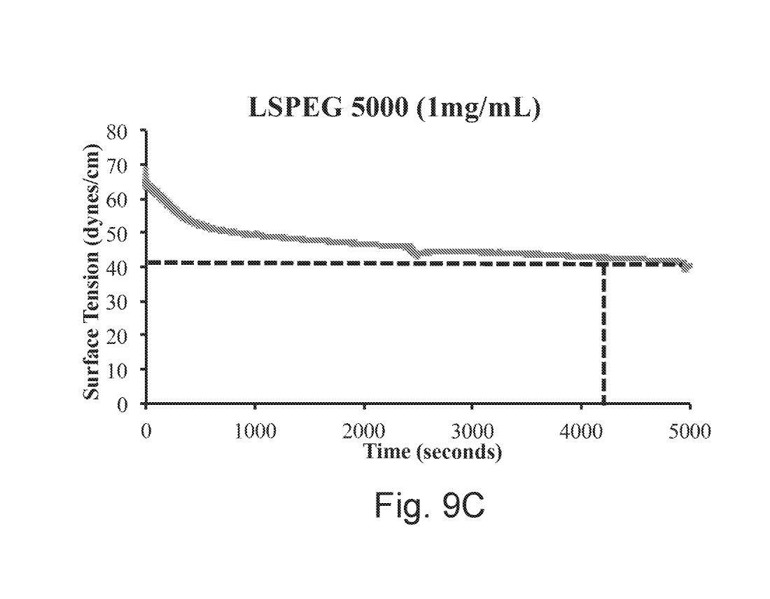

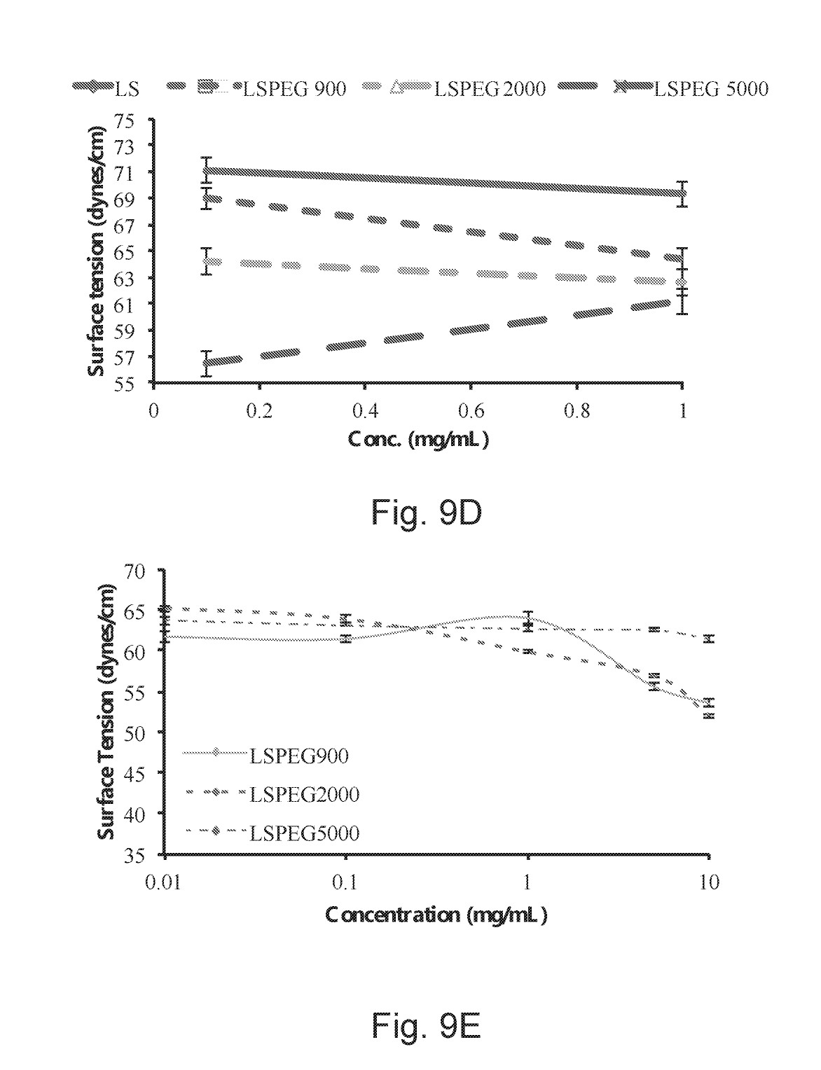

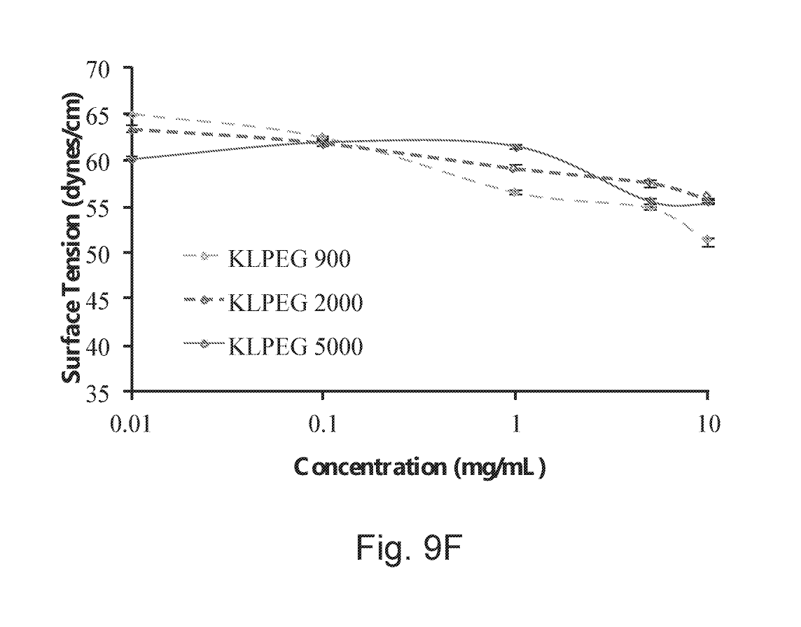

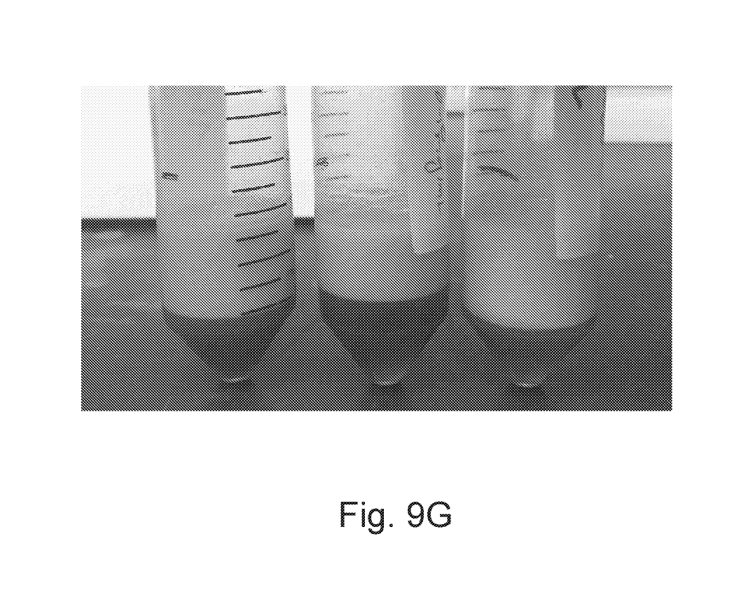

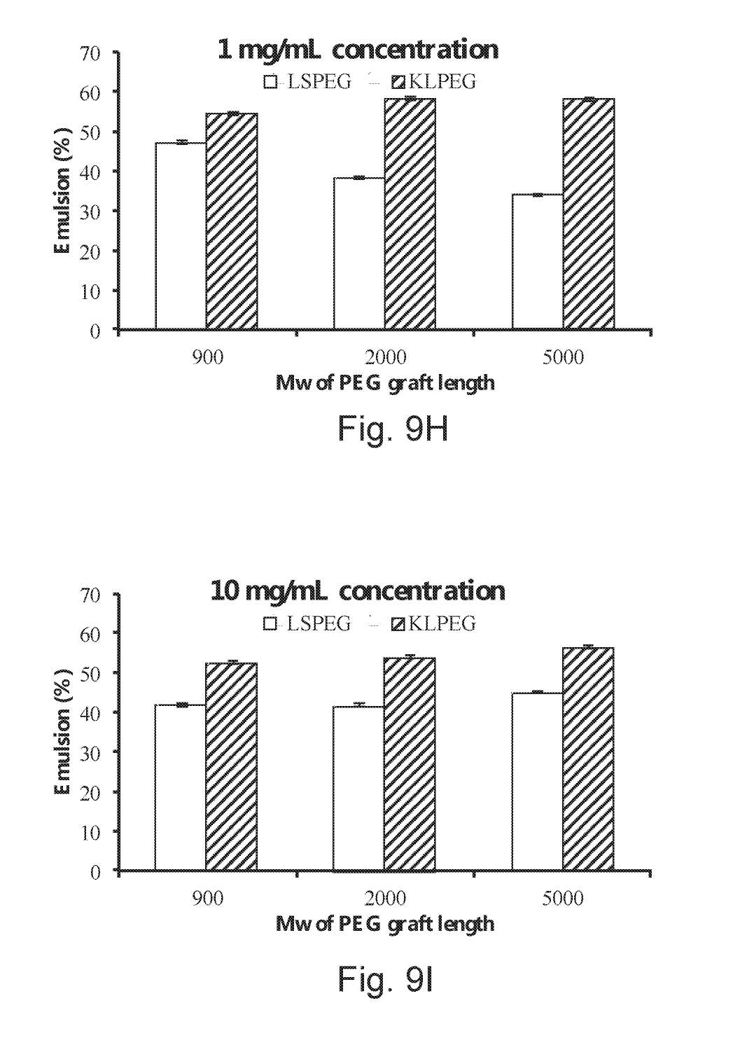

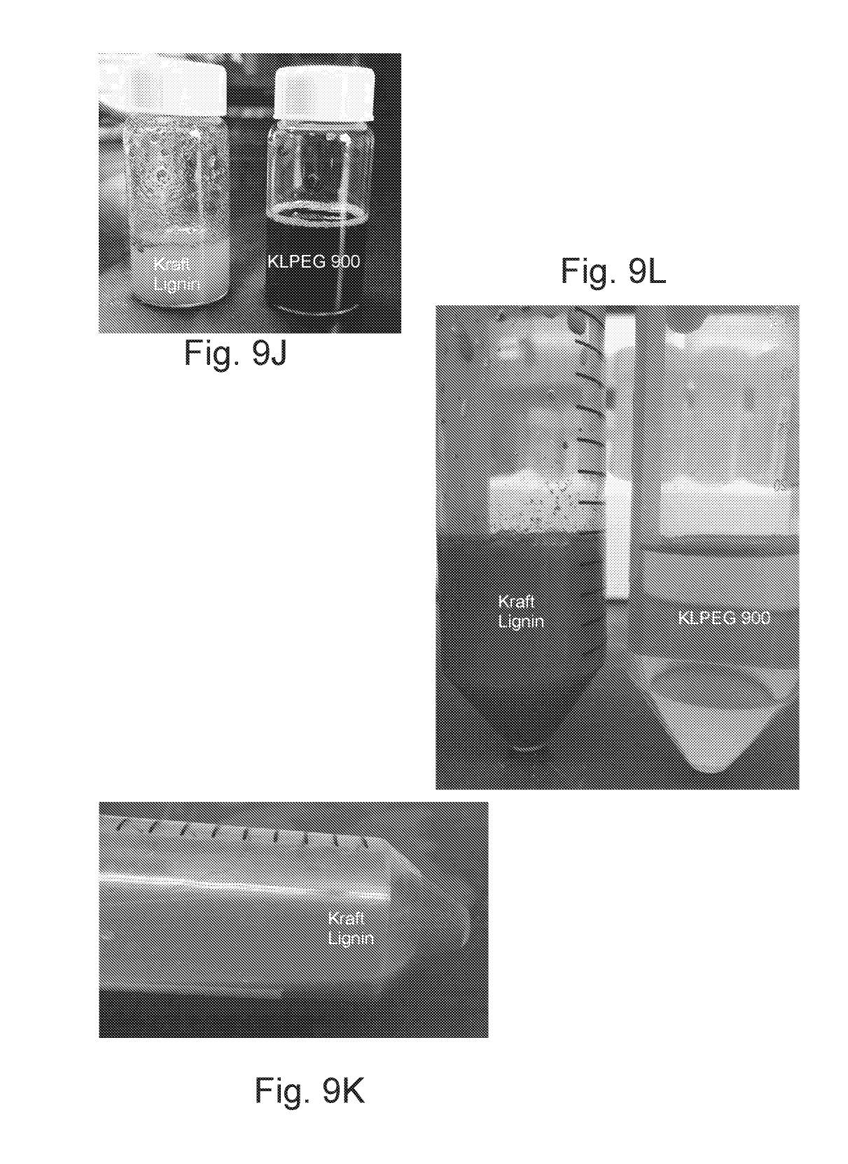

In studies of dynamic surface tension as illustrated in FIGS. 9A and 9B, KLPEG900 was found to have fasters dynamics that KLPEG5000 (τ˜100 sec for KLPEG900 verses τ˜400 sec for KLPEG5000), while each composition exhibited an equilibrium value of 40 dynes/cm. The increase in the time constant observed for KLPEG5000 (approximately 400 sec) indicates that differences in interfacial activities may be observed in the range of compositions investigated. These studies on KLPEG900 in particular demonstrate that even incorporation of low amounts of PEG can significantly enhance interfacial activities. As illustrated in a comparison of FIG. 9C to FIG. 9B, the equilibrium value of surface tension for LSPEG 5000 (FIG. 9C) is higher than KLPEG 5000 (FIG. 9B) by 3 dynes/cm. KLPEG 5000 also has faster dynamics then LSPEG 5000

In a number of studies of the equilibrium value of surface tension, three PEG molecular weights were compared in conjugation to LS and KL: 900 g/mol (LSPEG 900; KLPEG 900), 2000 g/mol (LSPEG 2000; LSPEG 2000), and 5000 g/mol (LSPEG 5000; KLPEG 5000). As illustrated in FIGS. 9D, 9D and 9F, the interfacial activities of three LSPEG compounds having PEG molecular weights of 900 g/mol, 2000 g/mol, and 5000 g/mol were assessed by measuring their effects on the surface tension of water. The surface tension of water is approximately 72 dynes/cm. LSPEG was added at concentrations of 0.1 mg/mL and 1.0 mg/mL in FIG. 9D, and at concentrations of 0.01 mg/mL, 0.1 mg/mL, 1.0 mg/mL 5.0 mg/mL and 10 mg/mL in FIG. 9E. KLPEG was added at concentrations of 0.01 mg/mL, 0.1 mg/mL, 1.0 mg/mL 5.0 mg/mL and 10 mg/mL in FIG. 9F. Higher PEG graft molecular weight resulted in slightly greater surface tension decrease at low concentrations. Without limitation to any mechanism, the complex concentration dependency may be related to aggregation.

The polymer-grafted lignins hereof were also found to form stable cyclohexane-in-waster emulsions, where the droplet size could be adjusted on the basis of graft density and PEG size. The average droplet size was found to be in the range of approximately 10 to 100 μm. Emulsions form when aqueous solutions of polymer-grafted lignin are vigorously mixed with immiscible organic solvents, such as cyclohexane. If the lignin species lacks interfacial activities, the water-cyclohexane mixture will rapidly phase separate into cyclohexane and water phases, but the formation of an emulsion composed of droplets of cyclohexane suspended in a continuous medium of water containing polymer-grafted lignin confirms the interfacial activities of these materials. In the studies of FIG. 9G through 9I, 10 mL of lignin grafted PEG was ultrasonicated with 10 mL of a cyclohexane-water mixture. Ultrasonication occurred at 85 W with pulsing amplitude of 70% for 5 minutes. The samples were allowed to sit for 24 hours. LSPEG/KLPEG 900, 2000 and 5000 were tested at concentration of 1 mg/mL and 10 mg/mL. FIG. 9G illustrates a photograph of KLPEG 900, KLPEG 2000 and KLPEG 5000 10 mg/mL (left to right) after two weeks. The emulsions were stable for months. The height of the emulsion is an indicator of the emulsifying power of each material. Comparing FIGS. 9H and 9I, it is seen that KLPEG is more effective than LSPEG with regard to emulsifying power in the water-cyclohexane systems studies. Further, the size of the PEG graft may be adjusted or tuned to have an predetermined effect on emulsion stabilization.

As shown in the water solubility studies of FIG. 9J through 9L, the kraft lignin used in the studies hereof is only slightly soluble in water. Most of the kraft lignin is observed to have settled to the bottom (see FIG. 9K) and the haziness of the solution indicates that the suspended particles were large enough to scatter light effectively. To the contrary, solutions of KLPEG900 were transparent and had low viscosity, indicating PEG grafting at approximately 10% by weight significantly enhanced solubility.

### Agricultural Material Studies

The effective delivery of agrochemicals, such as herbicides and insecticides, requires chemical adjuvants, which are generally considered to be surfactants. Such chemical adjuvants compatibilize the active compounds in a diversity of formulations. Representative functions of such chemical adjuvants include preventing precipitation or phase separation in complex solutions, promoting the formulation of appropriate droplet sizes in aerosols, enhancing wetting on plant surfaces, and facilitating transport into the plants. Two important applications of adjuvants are formulations adjuvants, which are included as a part of product and generally ensure homogeneity and stability of the solutions, and tank-mix adjuvants, which are added on site and optimize delivery for the specific crop, pests, and conditions. Diverse compounds are used as adjuvants, but many are synthetic chemicals that have associated toxicity and environmental persistence, which present significant drawbacks to their widespread use. Although lignins have intrinsic surfactant activities and have found use as agrochemical adjuvants, lignins grafted with hydrophilic polymers as described herein exhibit improved properties for use as, for example, agrochemical adjuvants.

Representative materials hereof based on lignin and a hydrophilic polymer such as PEG polymers were studied for use as surfactants or agrochemical adjuvants. In a number of studies, alkali lignin or kraft lignin (KL), was functionalized with the hydrophilic polymers such as PEG (see FIG. 1C) to prepare materials with a discrete lignin core and a PEG corona as illustrated in FIG. 1A. Results demonstrated that such a representative PEGylated kraft lignin (KLPEG) is both an effective dispersant for water-insoluble agrochemicals as well as an agent for facilitating uptake of agrochemicals in plants. The composition hereof provide a new type of agrochemical adjuvant with broad agricultural applications that increase commercial utility.

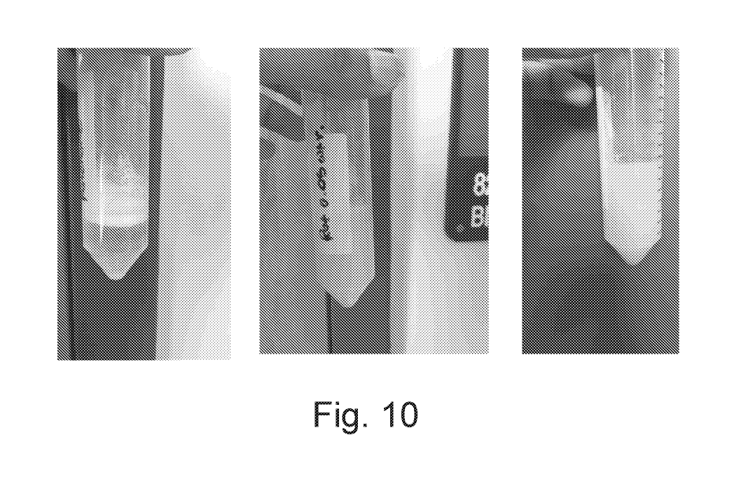

Studies demonstrated that PEGylated kraft lignin KLPEG is surface active and improves the dispersion and delivery of water-insoluble or hydrophobic agrochemicals. Water and 0.5 wt % of retenone (leftmost photograph of FIG. 10) does not mix. In representative studied, KLPEG900 was found to effectively disperse the water-insoluble herbicide rotenone at solution concentrations of 0.05 wt % and 0.1 wt % of KLPEG (see, for example, the center and rightmost photographs, respectively, of FIG. 10).

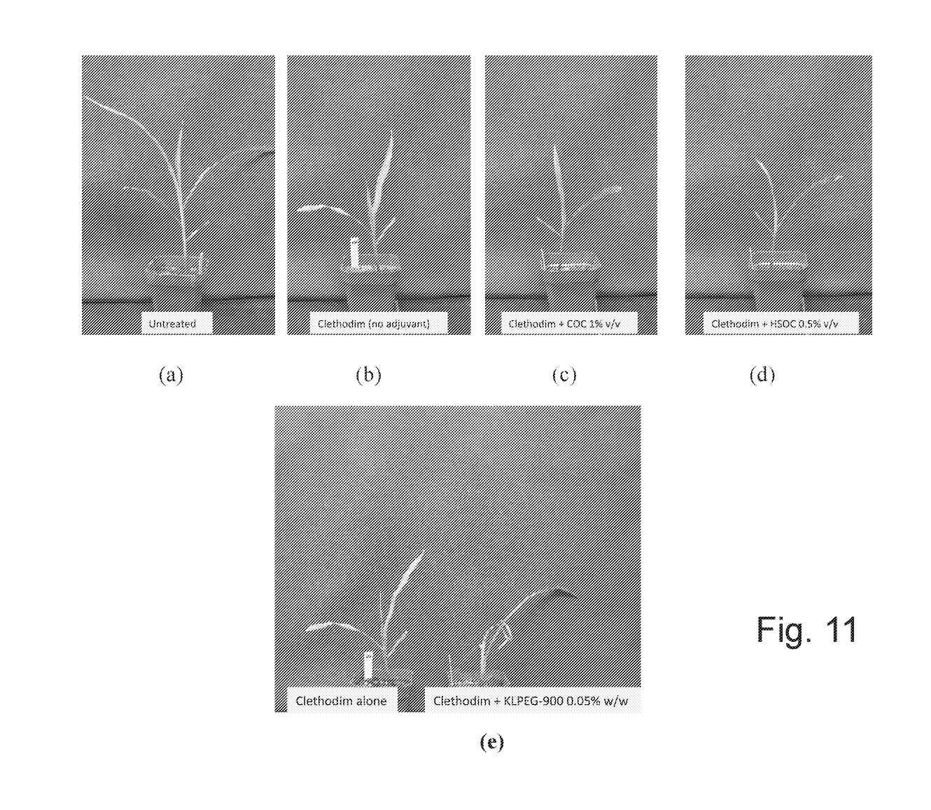

Various surfactants are used as adjuvants for agrochemicals to enhance deposition and penetration through plant surfaces. Two commercial tank-mix adjuvant systems that may be used for comparison are PRIME OIL® and SUPERB® HC (available from Winfield Solutions, LLC of Shoreview, Minn.), which are high surfactant oil concentrates. Representative studied were based on delivery of clethodim at 1 fluid ounce/acre, a commercial herbicide that inhibits growth of certain plants. A measure of effectiveness was the % inhibition (with 0% being no inhibition) compared to untreated control plants. Photographs (a)-(e) of FIG. 11 provide images of corn plants (corn being a common contaminant crop in soybean fields) treated with different formulations 7 days after treatment. Comparatively good results are obtained with clethodim and KLPEG900. Lignin adjuvant activity appeared to be higher at 0.05% v/v that 0.1% v/v.

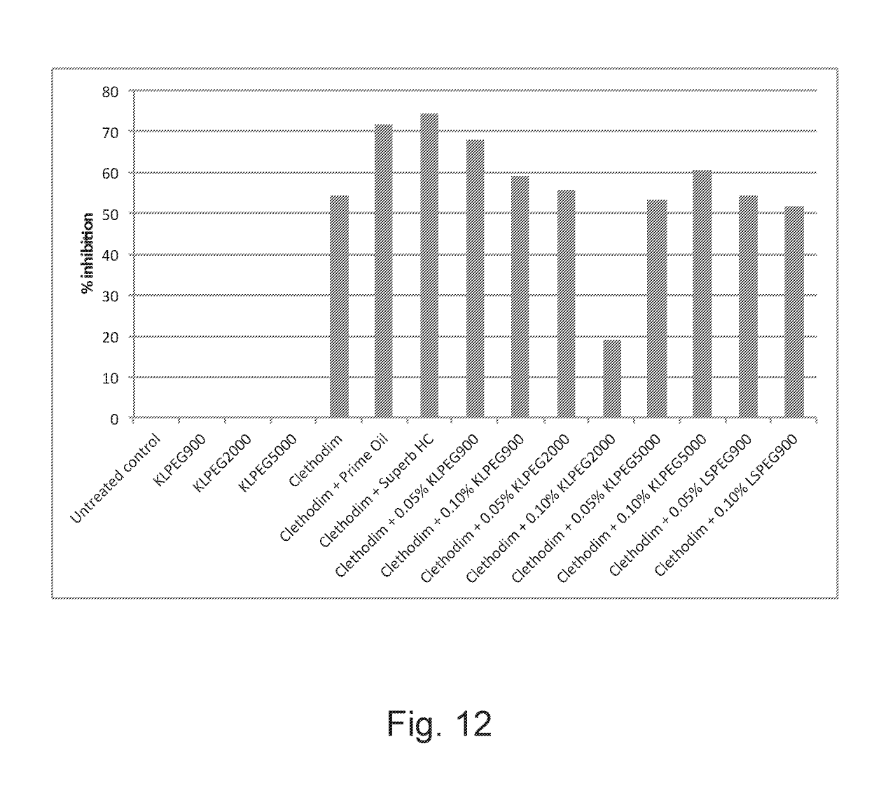

FIG. 12 illustrates a graph wherein % inhibition is plotted for the different formulations 7 days following treatment. None of the KLPEG derivatives showed any inhibition, indicating the lignin is non-toxic toward plants. Clethodim without tank-mix adjuvants had 54.4% inhibition while the formulations containing Prime Oil and Superb HC had 71.4% and 74.5%, respectively. The (non-optimized) inhibition values for KLPEG ranged from 68.0% for 0.05% KLPEG900 to 19.2% for 1.0% KLPEG2000. In general, the higher concentrations of KLPEG were found to be less effective than lower concentrations. Without limitation to any mechanism, this result may be attributable to greater aggregation at higher concentrations which reduced penetration. PEGylated lignosulfonate (LSPEG900) was also tested and found to be effective at similar concentrations, although it appeared to be slightly less effective than formulations based on KL.

In addition to use as surfactants, the polymer-grafted lignins hereof may be used as delivery agents or carrier agent for hydrophobic agents/compounds in aqueous media. In that regard, the lignin portion of the polymer-grafted lignins hereof may associate with or interact with a hydrophobic compound without chemically bonding thereto. In addition to hydrophobic agents/compounds such as clethodim, the polymer-grafted lignins hereof may operate as carrier agents for many other hydrophobic compounds/agents (for example, dyes).

The foregoing description and accompanying drawings set forth a number of representative embodiments at the present time. Various modifications, additions and alternative designs will, of course, become apparent to those skilled in the art in light of the foregoing teachings without departing from the scope hereof, which is indicated by the following claims rather than by the foregoing description. All changes and variations that fall within the meaning and range of equivalency of the claims are to be embraced within their scope.

1. A composition, comprising: a polymer-grafted lignin formed by grafting one or more hydrophilic polyalkylene oxide polymers with lignin, wherein the average grafting density of the polymer-grafted lignin is less than 10 per lignin particle and a weight fraction of the one or more hydrophilic polyalkylene oxide polymers in the polymer grafted lignin is less than 40%.

2. The composition of claim 1 wherein the average grafting density of the polymer-grafted lignin is no more than 6 per lignin particle.

3. The composition of claim 1 wherein the average grafting density of the polymer-grafted lignin is no more than 3 per lignin particle.

4. The composition of claim 1 wherein the one or more hydrophilic polyalkylene oxide polymers are polyethylene glycol polymers.

5. The composition of claim 3 wherein the one or more hydrophilic polyalkylene oxide polymers are polyethylene glycol polymers.

6. The composition of claim 1 wherein the one or more hydrophilic polyalkylene oxide polymers have a degree of polymerization in the range of 5 to 1000.

7. The composition of claim 1 wherein the one or more hydrophilic poyalkylene oxide polymers has a degree of polymerization in the range of 5 to 500.

8. The composition of claim 1 wherein the weight fraction of the one or more hydrophilic polyalkylene oxide polymers in the polymer-grafted lignin is less than 30%.

9. The composition of claim 1 wherein the weight fraction of the one or more hydrophilic polyalkylene oxide polymers in the polymer-grafted lignin is less than 20%.

10. The composition of claim 1 wherein the lignin is selected from the group consisting of a kraft lignin and a lignosulfonate.

11. The composition of claim 1 wherein the lignin is a lignosulfonate.

12. The composition of claim 3 wherein the one or more hydrophilic polyalkylene oxide polymers have a degree of polymerization in the range of 5 to 1000.

13. The composition of claim 3 wherein the one or more hydrophilic polyalkylene oxide polymers has a degree of polymerization in the range of 5 to 500.

14. The composition of claim 3 wherein the weight fraction of the one or more hydrophilic polyalkylene oxide polymers in the polymer-grafted lignin is less than 30%.

15. The composition of claim 3 wherein the weight fraction of the one or more hydrophilic polyalkylene oxide polymers in the polymer-grafted lignin is less than 20%.

16. The composition of claim 1 wherein the one or more hydrophilic polyalkylene oxide polymers have an average functionality of no more than 1.5.

17. The composition of claim 1 wherein the one or more hydrophilic polyalkylene oxide polymers have an average functionality of no more than 1.25.

18. (canceled)

19-37. (canceled)

38. A method of lowering a surface tension at a liquid-solid, liquid-liquid or a liquid-gas phase boundary in a composition including a liquid aqueous phase, comprising adding a surfactant to the liquid aqueous phase, the surfactant comprising a polymer-grafted lignin formed by grafting one or more hydrophilic polyalkylene oxide polymers with lignin, wherein an average grafting density of the polymer-grafted lignin is less than 10 per lignin particle and a weight fraction of the one or more hydrophilic polyalkylene oxide polymers in the polymer grafted lignin is less than 40%.

39. A method of delivering a hydrophobic compound in an aqueous medium, comprising: associating the hydrophobic compound with a carrier agent comprising a polymer-grafted lignin formed by grafting one or more hydrophilic polyalkylene oxide polymers with lignin, wherein an average grafting density of the polymer-grafted lignin is less than 10 per lignin particle and a weight fraction of the one or more hydrophilic polyalkylene oxide polymers in the polymer grafted lignin is less than 40%.

40-56. (canceled)
